(19) United States
(12) Patent Application Publication
(10) Pub. No.: US 2005/0225072 A1
(43) Pub. Date: Oct. 13, 2005

(54) Protective dust jacket cover and method of use

(76) Inventor: Timothy Elwell, Santa Ynez, CA (US)

Correspondence Address: NUTTER MCCLENNEN & FISH LLP, WORLD TRADE CENTER WEST, 155 SEAPORT BOULEVARD, BOSTON, MA, 02210-2604, US

(21) Appl. No.: 10/823,081

(22) Filed: Apr. 13, 2004

(51) Int. Cl. B42D 1/00

(52) U.S. Cl. 281/20

(57) ABSTRACT

A protective dust jacket cover is effective to functionally seal and protect a dust jacket. The cover protects the jacket from light, moisture, pests, and handling. In addition, the dust jacket can be functionally applied to a book when it is sealed within the protective dust jacket cover of the invention.

### FIELD OF THE INVENTION

The invention relates to methods and devices for protecting dust jackets of books and other forms of literature or periodicals.

### BACKGROUND OF THE INVENTION

Many books and other forms of printed matter use dust jackets to protect the book and to preserve its appearance while adding durability and artistic enhancement. However, dust jackets themselves are subject to wear and tear due repeated use and handling, as well as to environmental conditions. Consequently, protective book covers have been developed to provide some protection to books and their dust jackets.

Protection for dust jackets and the books that they cover is particularly important for dealers, collectors, and custodians of rare books. For such individuals the protection of dust jackets is essential. That is, dust jackets must be maintained in pristine condition to preserve the value of a book. By way of example, the value of a rare first edition book in excellent condition can vary by many orders of magnitude depending on whether the dust jacket is present and in fine condition, or missing or otherwise damaged.

One existing design for protective book covers is a paper or plastic sheet that covers the outer surface of the dust jacket. Examples of such covers are disclosed in U.S. Pat. Nos. 5,556,134 and 6,419,274. These patents describe transparent plastic covers for dust covers that provide some degree of protection for the books and dust jackets from repeated handling. While useful for libraries and other institutions that hold books that are frequently handled, these covers do not provide the level of protection for the dust jacket that is required to maintain the value of collector quality rare books.

Accordingly, there is a need for a dust jacket cover that can adequately protect dust jackets from the effects of time and environmental conditions to preserve the value and quality of the dust jackets and the books on which they are placed.

### SUMMARY OF THE INVENTION

The present invention provides a protective dust jacket cover and system in which the protective dust jacket cover is formed of a transparent outer sheet and a transparent inner sheet. The dust jacket cover is sealed on at least three sides and has an opening adjacent one side that communicates with a dust jacket-receiving space. A foldable flap is formed adjacent to the opening and extends from one of the outer sheet or the inner sheet beyond the other of the outer sheet or the inner sheet. The protective dust jacket cover further includes at least one adhesive layer formed on a portion of the surface of the foldable flap such that the foldable flap is adapted to be folded over the opening to seal the opening and to seal a dust jacket within a dust jacket-receiving space. Preferably, a selectively removable protective strip is disposed over the adhesive layer.

The protective dust jacket cover of the invention protects dust jackets from damage that may be caused by repeated handling and use, pests, and environmental factors such as light and moisture.

### BRIEF DESCRIPTION OF THE DRAWINGS

FIG. 1 is a front view of a protective dust jacket cover according to the present invention;

FIG. 2 is a side, sectional view of the protective dust jacket cover of FIG. 1;

FIG. 3 is a front view of the protective dust jacket cover of FIG. 1 having a dust jacket placed therein;

FIG. 4 is a side, sectional view of the protective dust jacket cover of FIG. 3;

FIG. 5 is a front view of the protective dust jacket cover of FIG. 3 in a partially sealed condition; and

FIG. 6 is a front view of the dust jacket protective cover of FIG. 3 in a fully sealed condition.

### DETAILED DESCRIPTION OF THE INVENTION

The protective dust jacket cover of the present invention is advantageous because it preserves and protects dust jackets of books. The dust jacket is sealed within the protective dust jacket cover of the invention so that it is immune to damage from light, moisture, pests, and repeated use and handling. The flexible nature of the protective dust jacket cover of the invention enables the dust jacket to be functionally applied to a book when the dust jacket is sealed and protected within the protective cover.

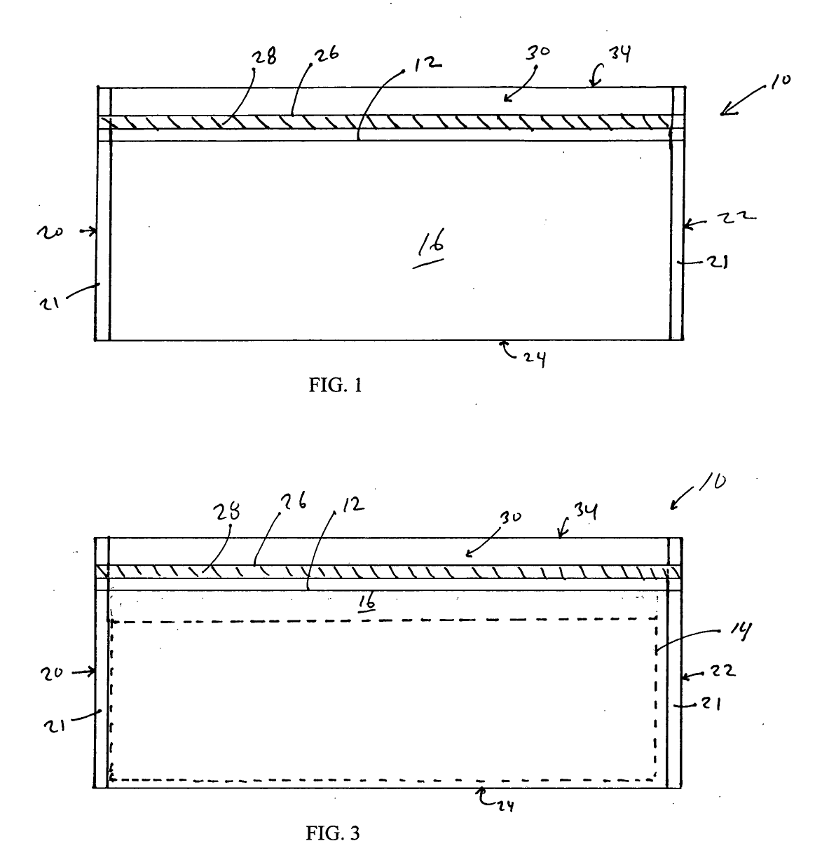

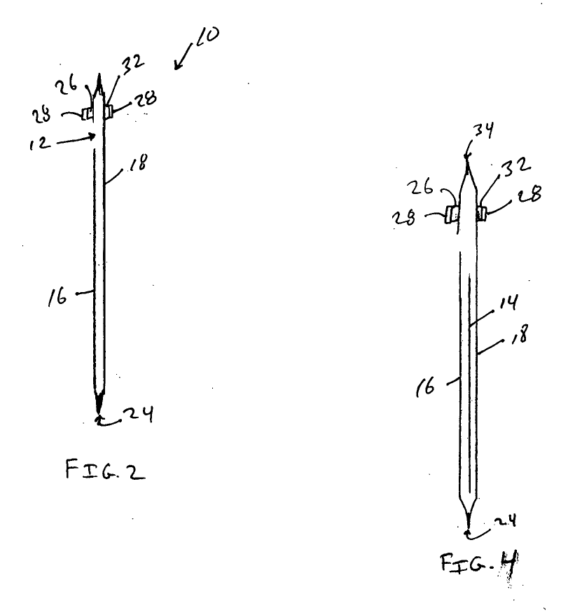

FIGS. 1 and 2 illustrate that the protective dust jacket cover 10 of the invention is formed of sheets of material, preferably transparent, that contain a selectively sealable opening 12 through which a dust jacket 14 (FIG. 3) can be inserted. The protective dust jacket cover 10 has a front sheet (16) and a back sheet (18) which are sealed along at least three sides. In one embodiment, the first and second sides 20, 22 are joined by a heat seal 21, and the front and back sheets are integral and the bottom side is in the form of a fold separating the front and back sheets 16, 18. Alternatively, the front and back sheets 16, 18 are separate and are heat sealed or otherwise permanently bonded together at the bottom end. One skilled in the art will appreciate that a variety of sealing or bonding techniques, including but not limited to heat sealing, can be used to join together separate sheets or portions of the same sheet.

An opening 12 is formed in or adjacent to one of the front and back sheets 16, 18. For purposes of illustration, FIG. 1 shows the opening 12 formed in front sheet 16. The opening 12 is sufficiently sized to enable a dust jacket to pass therethrough and into a dust jacket receiving space defined by the front and back sheets 16, 18. Adjacent to and above the opening 12 is a first adhesive strip 26 that is covered by a selectively removable protective strip 28. In addition, a portion of either the front or back sheets 16, 18 which forms a foldable flap 30, is adjacent to and above the first adhesive strip.

A person skilled in the art will readily appreciate that the opening can be constructed in a number of ways and the illustrative protective dust jacket cover described herein merely provides a single embodiment. In one embodiment the opening can be formed width-wise (as shown in FIG. 1) across the front sheet at a point between the top and bottom of the front sheet. In this embodiment, the front and back sheets are joined together at a top side of the protective dust jacket cover by heat sealing. Alternatively, the opening can be formed as a result of the front sheet being shorter than the back sheet. In this embodiment, the opening is formed adjacent to the top of the front sheet and the foldable flap is formed as an extension of the back sheet with the adhesive strips formed on either side of the back sheet. A person skilled in the art will understand other variations, including a length-wise opening, can also be utilized.

As illustrated in FIG. 2, a second adhesive strip 32 is formed opposite the first adhesive strip 26. The second adhesive strip is also covered by a selectively removable protective strip 28. The second adhesive strip is useful to provide a seal of added security, or to enable the size of the protective dust jacket cover to be adjusted, as discussed below.

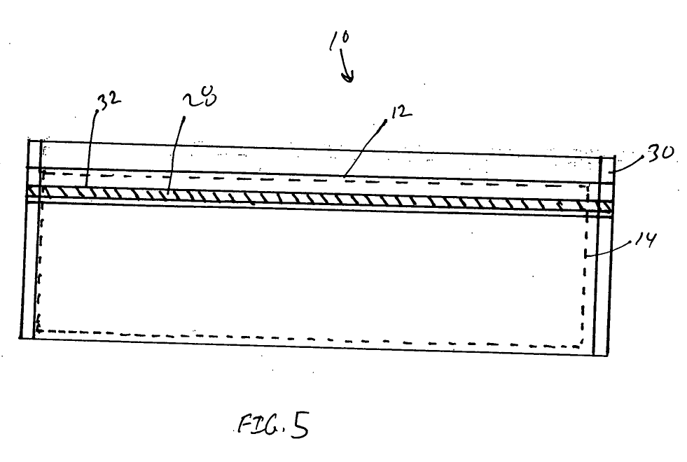

FIGS. 3 and 4 illustrate the protective dust jacket cover of FIGS. 1 and 2 in the unsealed condition, having a dust jacket 14 disposed therein. A person skilled in the art will appreciate that the dust jacket can be inserted into the protective dust jacket cover in a variety of ways without damaging the dust jacket.

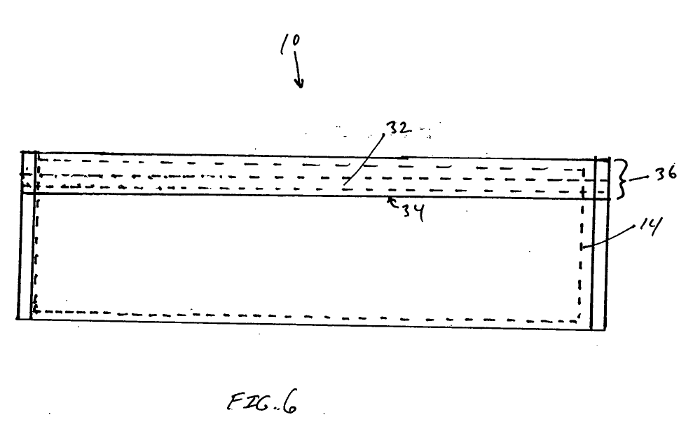

FIGS. 5 and 6 sequentially illustrate an exemplary technique for folding the protective dust jacket cover and sealing a dust jacket therein. As noted above, FIG. 3 illustrates a dust jacket disposed within the protective dust jacket cover with the protective dust jacket cover in the unsealed condition. As a first step in the sealing process, shown in FIG. 5, the protective strip 28 is removed from the first adhesive strip 26 and the foldable flap 30 is folded over and beyond the opening 12. In the illustrated embodiment, this folding action causes the first adhesive strip 26 to contact and seal upon front sheet 16. Optionally, another fold can be effected to further seal the protective dust jacket cover and also to reduce the height of the protective dust jacket cover. In this embodiment, second adhesive strip 32 (if present) is exposed by removing protective strip 28 and a desired amount of the top portion 34 is again folded over to seal upon the second adhesive strip 32 to form a second fold 36. The fully sealed protective dust jacket cover is shown in FIG. 6.

One skilled in the art will appreciate that the protective dust jacket cover can be sealed by a variety of alternative techniques. It is, however, important to fully enclose the dust jacket within the protective dust jacket cover and to seal the protective dust jacket cover from moisture and other environmental factors.

The protective dust jacket cover can be made from a variety of materials. Preferably, the cover is made from a flexible polymeric material. In one embodiment, the cover is a flexible polymeric sheet that is impermeable to moisture and air. In another embodiment, the flexible polymer is impervious to ultraviolet light and infrared light.

Exemplary materials from which the protective dust jacket cover can be made include polymers that can be extruded as flexible sheets. An exemplary class of polymers is polyolefins, with oriented polypropylene being particularly useful.

The cover may be formed in a variety of thicknesses. In an exemplary embodiment, the thickness is in the range of about 1 to 1.4 mils, and most preferably about 1.2 mils.

1. A protective dust jacket cover, comprising:
a dust jacket cover formed of a transparent front sheet and a back sheet, the dust jacket cover having at least three sealed sides and an opening adjacent one side communicating with a dust jacket-receiving space;
a foldable flap formed adjacent to the opening and extending from one of the front sheet or the back sheet beyond the other of the front or back sheets; and
an adhesive layer formed on a portion of the surface of the foldable flap, the foldable flap being adapted to be folded over the opening to seal a dust jacket within the dust jacket-receiving space.

2. The protective dust jacket cover of claim 1, further comprising a protective strip removably disposed over the adhesive layer.

3. The protective dust jacket cover of claim 1, wherein the foldable flap extends from the back sheet beyond the height of the front sheet and is adapted to be folded over the opening to adhere to the front sheet.

4. The protective dust jacket cover of claim 3, further comprising a second adhesive layer formed on an outer surface of the front sheet, the second adhesive layer having a protective strip removably disposed thereon.

5. The protective dust jacket cover of claim 1, wherein the inner sheet is transparent.

6. The protective dust jacket cover of claim 1, wherein the opening side is formed adjacent a top end of the dust jacket cover.

7. The protective dust jacket cover of claim 6, wherein a bottom end and opposed sides of the protective dust jacket are sealed.

8. The protective dust jacket cover of claim 6, wherein the front and back sheets are integral with one another and the sealed bottom end is formed by a fold between the front and back sheets.

9. The protective dust jacket cover of claim 8, wherein the opposed side ends of the dust jacket cover are heat sealed.

10. The protective dust jacket cover of claim 1, wherein the dust jacket-receiving space is impermeable to air, water, moisture, and pests when the foldable flap is closed and adhered.

11. The protective dust jacket cover of claim 1, wherein the dust jacket is made from a flexible polymeric material.

12. The protective dust jacket cover of claim 11, wherein the polymeric material is resistant to infrared and ultraviolet light.

13. The protective dust jacket cover of claim 11, wherein the polymeric material is a polyolefin.

14. The protective dust jacket cover of claim 1, wherein each of the outer sheet and the inner sheet have a thickness in the range of about 1 to about 1.4 mils.

15. The protective dust jacket cover of claim 14, wherein the outer and inner sheets have substantially the same thickness.

16. The protective dust jacket cover of claim 14, wherein the outer and inner sheets have different thicknesses.

17. A protective dust jacket cover, comprising:
a dust jacket cover formed of a transparent front sheet and a back sheet, the dust jacket cover having a dust jacket-receiving opening extending along at least a portion of one of the front and back sheets, the opening communicating with a dust jacket-receiving space defined by the outer and inner sheets;
a foldable flap formed adjacent to the dust jacket-receiving opening;
a first adhesive layer formed on at least one of the front and back sheets in proximity to the dust jacket-receiving opening; and
a protective strip removably disposed over the first adhesive layer, such that upon removal of the protective strip to expose the first adhesive layer, the front and back sheets are able to be adhered to each other to close the dust jacket-receiving opening and seal a dust cover within the dust jacket-receiving space.

18. The protective dust jacket cover of claim 17, wherein the front and back sheets are integral with one another and a sealed bottom end is formed by a fold between the front and back sheets.

19. The protective dust jacket cover of claim 18, wherein the opposed side ends of the dust jacket cover are heat sealed.

20. The protective dust jacket cover of claim 19, wherein the front and back sheets are heat sealed at a top end of the dust jacket cover.

21. The protective dust jacket cover of claim 19, wherein the opening is a slit formed in the inner sheet adjacent at least a portion of one of the opposed side ends, the top end or the bottom end.

22. The protective dust jacket cover of claim 19, wherein the opening is a slit formed in the back sheet adjacent to the top end of the dust jacket cover and the foldable flap is disposed above the slit.

23. The protective dust jacket cover of claim 22, wherein the first adhesive layer is formed on an inner surface of the foldable flap.

24. The protective dust jacket cover of claim 23, further comprising a second adhesive layer formed on an outer surface of the foldable flap, the second adhesive layer having a protective strip removably disposed thereon.

25. The protective dust jacket cover of claim 17, wherein the dust jacket-receiving space is impermeable to air, water, moisture, and pests when the foldable flap is closed and adhered.

26. The protective dust jacket cover of claim 17, wherein the dust jacket is made from a flexible polymeric material.

27. The protective dust jacket cover of claim 26, wherein the polymeric material is resistant to infrared and ultraviolet light.

28. A method of protecting a dust cover of a book, comprising:
providing a dust jacket protective cover formed of front and back sheets having at least three sealed ends and a dust jacket-receiving opening communicating with a dust jacket-receiving space;
inserting a dust jacket through the opening of the dust jacket protective cover; and
sealing the open end to hermetically seal the dust jacket within the dust jacket-receiving space.

29. The method of claim 28, wherein the dust jacket protective cover has a foldable flap adjacent to the opening.

30. The method of claim 29, wherein the foldable flap includes a first adhesive layer, formed on an inner surface thereof, covered by a removable protective strip.

31. The method of claim 30, wherein the foldable flap includes a second adhesive layer, formed on a front surface thereof, covered by a removable protective strip.

32. The method of claim 31, wherein the step of sealing is accomplished by removing the protective strip from the first adhesive layer, folding the foldable flap over the opening, and adhering the foldable flap to a portion of the back sheet.

33. The method of claim 32, wherein the step of sealing further comprises folding the foldable flap a second time to adjust the height of the dust jacket protective cover to the height of the dust jacket, removing the protective strip from the second adhesive layer and adhering the second adhesive layer to a portion of the back sheet.
